(19) United States
(12) Patent Application Publication
(10) Pub. No.: US 2007/0062885 A1
(43) Pub. Date: Mar. 22, 2007

(54) Method and apparatus for fractionating blood

(76) Inventor: Cesare Strisino, Lignano Sabbiadoro (IT)

Correspondence Address: SCULLY, SCOTT, MURPHY & PRESSER, 400 GARDEN CITY PLAZA, SUITE 300, GARDEN CITY, NY, 11530, US

(21) Appl. No.: 10/554,565

(22) PCT Filed: Apr. 28, 2004
(86) PCT No.: PCT/EP04/04474

§ 371 Date: Sep. 8, 2006

(30) Foreign Application Priority Data
Apr. 30, 2003 (IT) MI2003A000897

(51) Int. Cl. C02F 1/38

(52) U.S. Cl. 210/787; 210/789; 210/804; 210/512.1; 604/6.01; 604/410; 494/37

(57) ABSTRACT

A method and an apparatus for processing blood in a closed system in order to obtain fractionation of the corpusculate part and preferably the separation of the white cells from the red cells according to their sedimentation rate and maintain a high degree of vitality of the cells. The white blood cells are sequestered from the remaining cell population of the blood by placing the blood in a container, preventing its coagulation and separating the blood by means of a sedimentation agent in at least two compartments, one of which is extremely rich in white cells.

### TECHNICAL FIELD

The present invention relates to a method and an apparatus for fractionating the corpusculate part of a blood sample.

### BACKGROUND ART

The constant increase in blood cell manipulation procedures for therapeutic applications has brought about new requirements in their manipulation, particularly in the field of cryopreservation and of ex vivo expansion.

In the prior art description that follows, cord blood (designated by CB) is used as an exemplifying and non-limiting application.

CB is acknowledged to be a rich source of stem/progenitor cells and is used as an alternative source to bone marrow and peripheral blood for the treatment of a variety of diseases both in the pediatric age and in adults.

CB transplantation currently has been associated:
with a reduced risk of developing graft versus host disease (GVHD) even when using cells of a donor with limited compatibility of the major histocompatibility complex (MHC) with respect to the recipient;
with immediate availability for transplantation;
with a source that implies no risks for the mother or for the newborn, since the umbilical cord and the placenta are typically waste products;
with a low transmission of infectious agents.

Since the first CB transplant from an unrelated donor, which occurred in 1988, over 2000 CB transplants have been performed so far worldwide. Almost simultaneously, CB banks have been set up, and more than 160,000 cryopreserved units of CB are currently available.

The exponential increase in the number of umbilical cord blood banks has revealed new problems, including the storage of large volumes of whole cryopreserved units, leading to the need to freeze separate products of the only blood component of interest. In order to reduce space occupation and operating costs in the storage of cryopreserved units, reduction of the volume of CB is now currently widely used in storage operations.

During the last years, due to the limited content of hematopoietic progenitor cells present in a single cord blood unit, new clinical procedures have been developed which provide for the ex vivo expansion of said cells in order to obtain a number of hematopoietic progenitor cells sufficient to allow transplantation into adult patients. These ex vivo expansion procedures require a selection of the population of interest starting from a product that is rich in white cells (WC) and depleted of red cells (RC).

In recent times, various methods for separating WC from RC, aimed at ensuring reduction of the final volume of the sample, enrichment of the cell fraction of interest (white cells and hematopoietic progenitor cells) and elimination of contaminating cells (red cells and platelets) have been developed.

These goals have been achieved only partially by systems that use centrifugal force to separate the samples into the various fractions and are based on the application of closed circuits of multiple bags that are not dedicated but can be implemented by means of manual or automated infusion-pressor separators.

The centrifugation procedure has significant disadvantages, since it does not ensure a sufficient reduction of the volume that allows storage with mechanized cryopreservation systems; moreover, the product obtained after separation by centrifugation has a high rate of contamination with red cells (RC depletion lower than 50%), which are responsible for hemolytic phenomena and condition subsequent treatments for purification and ex vivo expansion of the product.

These disadvantages, which can be ascribed to centrifugation procedures, have been partially overcome by using nonselective substances, such as gelatin, hydroxyethyl starch (Yang H. et al., Bone Marrow Transplantation 2001, 27: 457-461; U.S. Pat. No. 5,789,147, Rubinstein et al.; U.S. Pat. No. 5,928,214, Rubinstein et al.; WO 9617514, Rubinstein et al.) and dextrane (Tsang S. et al., Transfusion 2001, 41: 344-352), as separation/sedimentation agents.

In recent years, closed circuits of multiple bags, “dedicated” exclusively to the processing of cord blood, have been developed which use nonselective sedimentation agents (U.S. Pat. No. 5,879,318).

However, these circuits are limited to the steps for collecting and processing the sample and do not consider the subsequent step of cryopreservation/storage of the final product, which still requires manipulation in an environment with controlled contamination.

These sedimentation agents allow, exclusively with the aid of a centrifugation step, to separate the sample into two fractions: a fraction that is rich in WC (containing the cell fraction of interest) and a fraction that contains the RC (waste fraction).

Application of centrifugal force in the process is necessary both in order to limit sedimentation times, which are per se extremely long, and in order to ensure acceptable results in terms of separation yield (recovery of the WC-rich fraction).

Some protocols, in order to optimize recovery of the fraction of interest, have two sedimentation steps, doubling the processing time, which despite centrifugation is still longer than one hour for each sedimentation step.

In any case, said sedimentation agents have allowed to obtain a product that is improved in terms of volume reduction and red cell depletion with respect to procedures with simple centrifugation of the sample. However, these results so far are not sufficient to implement the product with subsequent purification procedures for ex vivo expansion of the cells of interest.

The use of dedicated filters has been tested recently and does not allow a recovery of the fraction of interest comparable with the above cited separation systems.

### DISCLOSURE OF THE INVENTION

The aim of the present invention is to provide a method and an apparatus for fractionating the corpusculate part of blood that overcome the drawbacks of the known art.

Within this aim, an object of the present invention is to provide a method and an apparatus for separating red cells from white cells in blood.

Another object of the present invention is to provide a method and an apparatus for fractionating the corpusculate part of blood that allow better reduction of the final volumes of the isolated blood fractions.

Another object of the invention is to provide a method and an apparatus for fractionating the corpusculate part of blood that allow to eliminate the need for centrifugation of the sample during separation with the sedimentation agent.

Another object of the invention is to provide a method and an apparatus for fractionating the corpusculate part of blood that avoid subsequent manipulation in controlled-contamination environments for storage of the isolated blood fractions.

This aim and these and other objects that will become better apparent hereinafter are achieved by the method for gravimetric fractionation of the corpusculate part of a blood sample and for subsequent storage of at least one of the selected fractions, said method comprising the following steps: a) collecting a blood sample; b) mixing said blood sample with an anticoagulant solution; c) adding to said blood sample, mixed with said anticoagulant solution, a sedimentation solution; d) recovering at least two fractions into which said blood sample has separated, wherein at least one of said fractions is enriched in red cells and at least one of said fractions is enriched in white cells, stem cells and progenitor cells; e) centrifuging a fraction of interest recovered from step d); and f) recovering from step e) the corpusculate fraction and mixing it with a preservative solution for blood derivatives.

The above cited aim and objects are also achieved by an apparatus for gravimetric fractionation of the corpusculate part of a blood sample, characterized in that it comprises: a) a needle for collecting the blood sample; b) a closed and sterile system of bags, which comprises at least i) a first compartment for collecting said blood sample, which comprises an anticoagulant solution, ii) a second compartment, which comprises a sedimentation solution, iii) a third compartment for fractionating the blood sample, iv) a fourth compartment for centrifugation of a selected blood fraction, v) a fifth compartment, which comprises a preservative solution for blood derivatives, vi) a sixth compartment for storing a selected blood fraction and vii) clips and cocks suitable to allow isolation of the various compartments, wherein each compartment comprises at least one bag.

The present invention relates to a method for separating cells contained in blood and to apparatuses consisting of bags orientated sequentially for collecting and processing blood and cryopreserving/storing the final product, preferably to a method for obtaining separation of red cells from white cells according to their sedimentation rate.

In the present invention, the sedimentation solution comprises a sedimentation agent selected from the group that consists of polygeline, hydroxyethyl starches, dextranes, gelatin and mixtures thereof.

In particular, the sedimentation solution comprises polygeline and even more preferably a solution of 3.5% polygeline by weight.

The method uses a sedimentation agent that preferably comprises polygeline and leads to separation by sedimentation of red cells from white cells in a closed circuit.

The method described hereinafter as an exemplifying and non-limiting model provides for separation of WC from RC and for subsequent optional volume reduction with minimal loss of stem/progenitor cells.

The method and the apparatus according to the invention do not require centrifugation for sedimentation, with the advantage, with respect to the background art, of reduced manipulation of the sample and consequent reduction of cell damage as well as reduced risk of contamination.

The present method and apparatus allow results that are substantially superior to those provided by known methods, ensuring 95% average RC depletion and 93% stem/progenitor cell recovery, together with 87% WC recovery. Advantageously, the fraction enriched in white cells also contains stem cells and progenitor cells.

Furthermore, the method and the apparatus according to the invention allow to reduce the processing time to 50 minutes, allowing a good recovery of WC and of stem/progenitor cells, reduction of the volume of the sample, and a RC depletion that makes the final product ideal for purification/ex vivo expansion procedures.

The method and the apparatus according to the invention can be applied to samples such as for example marrow blood, cord blood, peripheral blood, and products of apheresis procedures.

The present invention can be used for several clinical and laboratory applications, such as:
separation of WC from RC in order to reduce the volume of the samples to be cryopreserved;
separation of WC from RC for subsequent manipulation of the WC for purification and ex vivo expansion.

Further possible applications are:
separation of WC from RC to reduce ABO incompatibility damage;
separation of WC from RC in order to obtain a lymphocyte-rich fraction that is useful to produce a graft-versus-residual diseased host cell reaction;
separation of WC from RC in apheresis products, when they are highly contaminated by RC;
separation of RC from WC from peripheral blood for autodonation of the RC-rich fraction;
separation of RC from WC from cord blood for transfusion of autologous RC in preterm newborns.

The advantages that can be obtained by the invention are:
high recovery of WC and stem/progenitor cells, associated with minimum contamination with RC and platelets;
drastic reduction in the final volume of the cell product, requiring minimum storage space and the addition of a limited volume of cryopreservative;
implementability with subsequent manipulation procedures, such as the selection of cell populations and ex vivo expansion;
a system that can be automated and ensures high reproducibility of the results independently of the operator;
a system that uses reagents approved for in vivo use;
a system that can be implemented easily with hospital and laboratory facilities, in the specific case of CB starting from the collection in the delivery room to the processing/freezing laboratory; for other samples, starting from the clinic to the laboratory;
a procedure for separating WC from RC in a closed system, capable of ensuring the safety and vitality of the cells in the final product, which allows to avoid exposure to bacterial and/or fungal contamination, to potentially harmful chemical, physical and mechanical agents, starting from the collection of the sample and ending with the cryopreservation/storage of the final product.

Merely by way of non-limiting example, the application of the invention for separating WC from RC starting from cord blood is described.

The invention relates to a method by means of which the WC fraction that contains the stem/progenitor cells is separated from the other components in the whole CB sample and is concentrated in a reduced volume of no more than 20 ml, requiring less storage space, a limited volume of cryopreservative, ensuring implementation with automated freezing systems and allowing subsequent manipulation procedures such as the selection of cell populations or ex vivo expansion.

More specifically, the method and the apparatus according to the invention substantially have the following characteristics:
the use of an anticoagulant solution, such as preferably heparin;
the use of a RC sedimentation solution preferably comprising polygeline;
they do not require centrifugation for sedimentation, thus preserving the vitality of cell sub-populations, such as stem/progenitor cells.

In the present description, the term “apparatus” is understood to indicate a “sterile/closed” system of bags that can comprise:
a sterile/closed system of bags;
a compartment that contains an anticoagulant, such as heparin, to which the sample being considered is then added, and an adequate volume of RC sedimentation solution, which preferably consists of a 3.5% solution of polygeline, used at a final concentration that is preferably comprised between 2:1 and 5:1 with respect to the sample, where the ratio is expressed by weight or by volume.

CB sedimentation preferably with polygeline allows excellent recovery of the white cell and stem/progenitor cell fraction, a considerable reduction of red cell contaminations, and a drastic reduction in the final volume of the processed sample.

The apparatus can be used in clinical applications; the procedure is quick, operator-independent and devoid of risks of bacterial/fungal contamination during processing. The protocol can have important implications in large-scale CB storage operations in order to obtain a product that can be implemented with mechanized cryopreservation systems and with procedures for purification and ex vivo expansion of the cells of interest.

### BRIEF DESCRIPTION OF THE DRAWINGS

Further characteristics and advantages of the invention will become better apparent from the description of preferred but not exclusive embodiments of the apparatus and the method according to the invention, illustrated by way of non-limiting example in the accompanying drawings, wherein:

FIG. 1 is a block diagram of a first embodiment of the apparatus according to the present invention;

FIG. 2 is a block diagram of a second embodiment of the apparatus according to the present invention.

### WAYS OF CARRYING OUT THE INVENTION

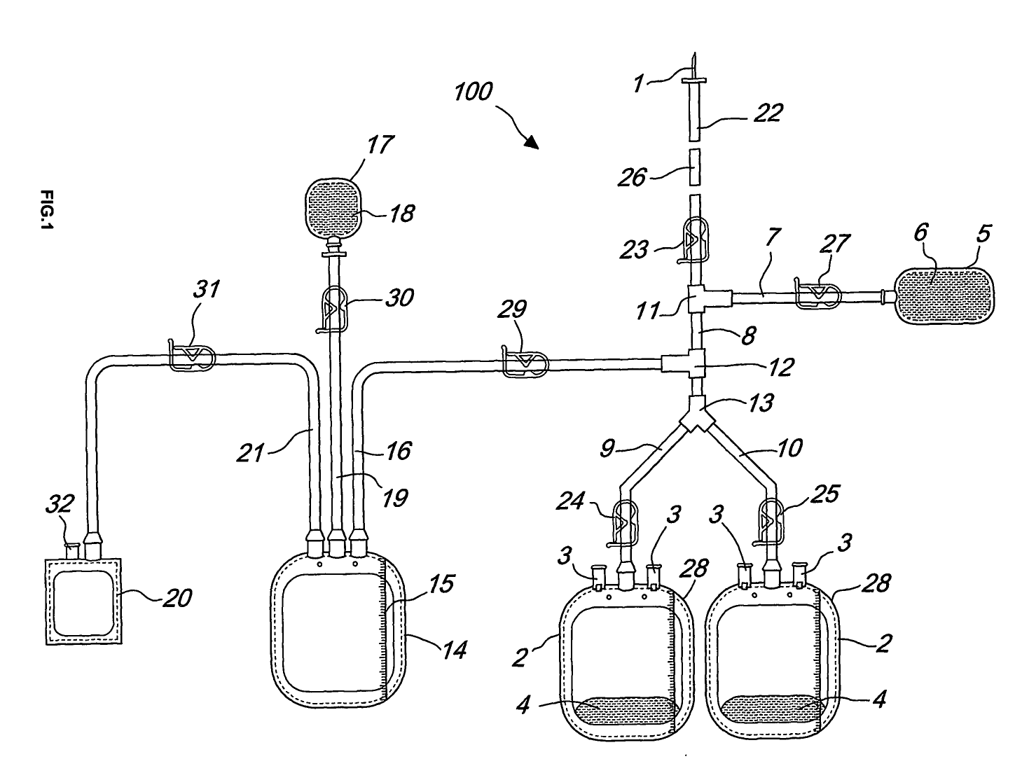

With reference to FIG. 1, the reference numeral 100 designates an apparatus according to the present invention in a first embodiment.

The apparatus consists of a collection needle 1, which is connected to two collection/sedimentation bags 2, each of which is provided with sampling points 3 and contains an anticoagulant solution 4. A bag 5, which contains a sedimentation solution 6, is connected to the bags 2 by means of ducts 7, 8, 9, 10 and three three-way devices 11, 12 and 13. The bags 2 are connected to a centrifugation bag 14, which is provided with a graduated scale 15, by means of a duct 16. The bag 14 is connected to a bag 17, which contains a preservative/cryopreservative solution 18, by means of a duct 19, and to a transport/preservation/cryopreservation bag 20 by means of a duct 21. All the clips provided in the apparatus 100 are closed at the beginning of the procedure.

The blood is collected by means of the needle 1 through the duct 22 into the collection/sedimentation bags 2 after opening the clips 23, 24 and 25. After collection, a portion 26 of the blood sample can be drawn for laboratory analysis, the needle is sealed and disconnected form the apparatus 100, and the clip 23 is closed; the blood is then mixed with the anticoagulant solution 4 in the bags 2.

To allow sedimentation of the RC, the required volume of sedimentation solution 6 comprising polygeline, contained in the bag 5, is introduced in the bags 2 through the ducts 7, 8, 9, 10 after opening a clip 27. The amount of sedimentation solution/polygeline that is required is calculated on the basis of a graduated scale 28 that is provided on the bags 2, complying with the recommended ratio between the volume of sedimentation solution/polygeline and the volume of blood. The ratio between the sedimentation solution and the blood can vary between 2:1 and 5:1, preferably 3:1, where the ratio is expressed by weight or by volume. After introducing the sedimentation solution/polygeline, the clip 27 is closed and the tube 8 is sealed and disconnected from the apparatus 100.

After 30-40 minutes of sedimentation at ambient temperature with the bags 2 in a vertical position have elapsed, the clip 29 is opened and the leukocyte-rich supernatant is transferred, by means of a manual/automated plasma extractor, into the centrifugation bag 14 by means of the duct 16, and the clips 24, 25 and 29 are closed. One of the collection/sedimentation bags 2 can be sealed and disconnected from the apparatus 100.

The apparatus 100 is centrifuged at 700 g for 10 minutes at ambient temperature; the clip 29 is then opened and the supernatant is transferred from the bag 14 to the remaining bag 2 by means of the tube 16, 9 or 10. The clips 29, 24 or 25 are closed and the duct 16 is sealed and disconnected from the apparatus 100.

The preservative/cryopreservative solution 18 contained in the bag 17 is added to the leukocyte-rich sediment in the bag 14 by means of the duct 19 after opening the clip 30. The bag 17 is sealed and disconnected from the apparatus 100 after closing the clip 30. The clip 31 is opened and the cells are transferred from the bag 14, through the duct 21, into the cryopreservation/preservation/transport bag 20. The sampling point 22 allows optional sampling of the final product for further testing.

Advantageously, the apparatus 100 has, regardless of the association with the other elements described above, a manual/automatable infusion set or drip feeder, provided for example on the line 19 and before the clip 30, to control the inflow of the cryopreservation solution. This aspect is important, since it allows to introduce the cryopreservation solution at a controlled rate, helping to avoid damage to the cells to be frozen.

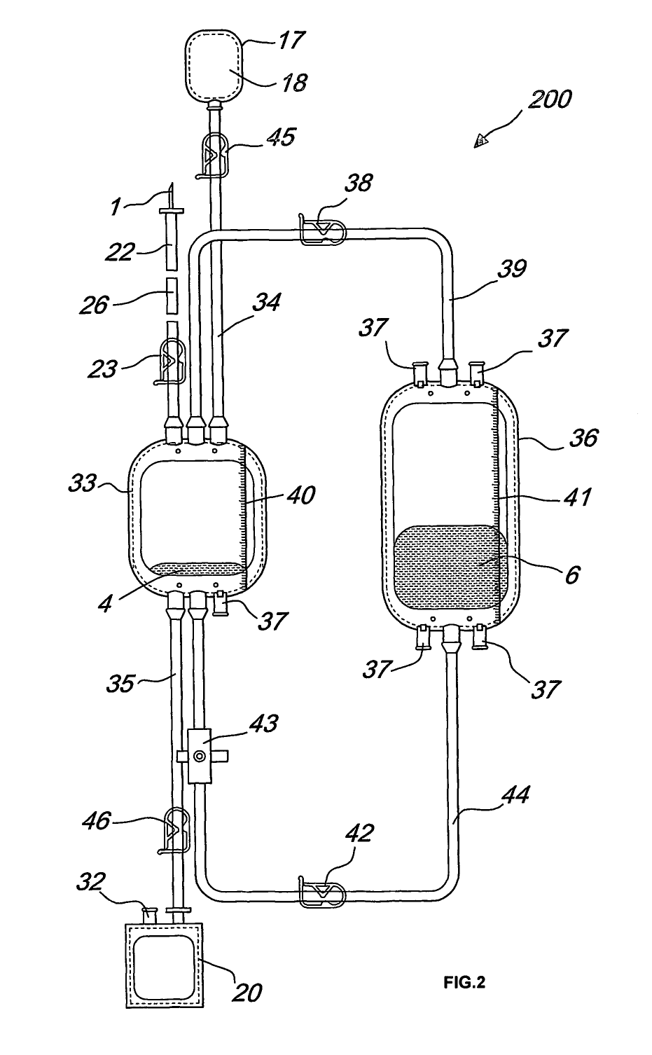

With reference to FIG. 2, the reference numeral 200 designates an apparatus according to the present invention in a second embodiment.

It should be noted that the reference numerals used in FIG. 2, which correspond to the reference numerals of FIG. 1, refer to identical elements.

The apparatus consists of a collection needle 1, which is connected to a collection/sedimentation bag 33, which contains an anticoagulant solution 4 and is connected to a bag 17 that contains a preservative/cryopreservative solution 18 by means of a duct 34, to a cryopreservation/preservation/transport bag 20 by means of a duct 35, and to a bag 36 that contains a sedimentation solution 6 by means of ducts 39 and 44. The bags 33 and 36 have sampling points 37. All the clips and cocks/infusion sets provided in the apparatus 200 are closed at the beginning of the collection procedure.

Blood is collected with the needle 1, by means of the tube 22, in the collection/sedimentation bag 33, and a portion 26 of the blood sample can be drawn for laboratory analysis. After collection and after closing the clip 23, the blood is mixed with the anticoagulant solution 4 in the bag 33 and the needle connected to the duct 22 is sealed and disconnected.

To allow RC sedimentation, the clip 38 is opened and the required quantity of sedimentation solution 6 comprising polygeline, contained in the bag 26, is introduced by gravity, manually or in an automatable manner, in the bag 33 by means of the tube 39, placing the bag 36 at a higher level than the bag 33. The amount of sedimentation solution, preferably polygeline, that is required is calculated on the basis of graduated scales 40 and 41 provided respectively on the bags 33 and 36, which allow to obtain the correct ratio between the volume of the sedimentation solution/polygeline and the volume of the blood. The ratio between the sedimentation solution and the blood can vary from 3:1 to 5:1, preferably 3:1, where the ratio is expressed by weight or by volume. The clip 38 is then closed.

After 30-40 minutes have elapsed for sedimentation at ambient temperature with the bag 33 in the vertical position, the clip 42 is opened and therefore the sediment of red cells is transferred by gravity, manually or in an automatable manner, through a cock/infusion set 43 and a duct 44 into the bag 36, positioning said bag at a lower level than the bag 33; the clip 42 is then closed and the duct 44 is sealed and disconnected from the apparatus 200.

The apparatus 200 is centrifuged at 700 g for 10 minutes at ambient temperature. After the single centrifugation step, the clip 38 is opened and the leukocyte-depleted supernatant is transferred, by means of a manual/automated plasma extractor, into the bag 36 by means of the duct 39; the clip 38 is then closed and the duct 39 and the bag 36 are sealed and disconnected from the apparatus 200.

After opening the clip 45, the leukocyte-rich sediment present in the bag 33 receives the addition of the preservative/cryopreservative solution 18 contained in the bag 17 through the duct 34. After mixing the cells with the preservative/cryopreservative solution 18, a portion of said cells can be collected from the sampling point 37 for further testing, and the clip 45 is closed and the duct 34 is sealed and disconnected from the apparatus 200.

After opening the clip 46, the cells thus treated are transferred by gravity by means of the tube 35 into the preservation/transport/cryopreservation bag 20. A portion of the separated white cells can be collected from the sampling point 32 for further testing.

As in the apparatus 100, the apparatus 200 too advantageously provides for the presence of a manual/automatable infusion set or drip feeder, provided for example on the line 34 and upstream of the clip 45, so as to be able to control the inflow of the cryopreservation solution. The advantages of this optional aspect are achieved independently of the association with the other elements described above for the apparatus according to the invention.

The above discussion has described the application to cord blood, with the purpose of separating WC from RC and of concentrating them in a reduced volume; an identical process can be applied to further sources of these cells, such as bone marrow, peripheral blood, and apheresis procedure-derived products.

The present invention has been illustrated, described and defined with reference to a particular method of providing the invention; this reference does not imply a limitation of the invention and no limitation must be inferred. The preferred, illustrated and described method of providing the invention is merely an example and does not exhaust the scope of the invention.

The disclosures in Italian Patent Application No. MI2003A000897 from which this application claims priority are incorporated herein by reference.

1. A method for gravimetric fractionation of the corpusculate part of a blood sample and for subsequent storage of at least one of the selected fractions, said method comprising the following steps:
a) collecting a blood sample;
b) mixing said blood sample with an anticoagulant solution;
c) adding to said blood sample, mixed with said anticoagulant solution, a sedimentation solution;
d) recovering, after sedimentation of the sample, at least two fractions into which said blood sample has separated, wherein at least one of said fractions is enriched in red cells and at least one of said fractions Is enriched in white cells, stem cells and progenitor cells;
e) centrifuging a fraction of interest recovered from step d);
f) recovering from step e) the corpusculate fraction and mixing it with a preservative solution for blood derivatives.

2. The method according to claim 1, wherein said blood fraction of interest recovered from step d) is the fraction enriched in white cells, stem cells and progenitor cells.

3. The method according to claim 1, wherein said blood fraction of interest recovered from step d) is the fraction enriched in red cells.

4. An apparatus for gravimetric fractionation of the corpusculate part of a blood sample, comprising:
a) a needle for collecting the blood sample;
b) a closed and sterile system of bags, which comprises at least:
i) a first compartment for collecting said blood sample, said compartment comprising an anticoagulant solution,
ii) a second compartment, which comprises a sedimentation solution,
iii) a third compartment for fractionating the blood sample,
iv) a fourth compartment for centrifugation of a selected blood fraction,
v) a fifth compartment, which comprises a preservative solution for blood derivatives,
vi) a sixth compartment for storing a selected blood fraction, and
vii) clips and cocks suitable to allow isolation of the various compartments, wherein each compartment comprises at least one bag.

5. The apparatus according to claim 4, wherein said at least one bag is shared between two or more compartments.

6. The apparatus according to claim 4, wherein said bag is provided with sampling points that are suitable for taking samples during the various steps of fractionation.

7. The apparatus according to claim 4, wherein said bag is provided with a graduated scale.

8. The apparatus according to claim 4, wherein said bags are sealed and disconnected from the entire apparatus during fractionation of said blood sample or at the end of their use.

9. The apparatus according to claim 4, comprising a manual/automatable infusion set or drip feeder for controlling the inflow of the cryopreservation solution.

10. The apparatus according to claim 4, wherein said collection needle is connected to two bags meant to collect the blood sample, said two bags containing an anticoagulant solution, fractionation of said sample occurring inside said bags, said two collection bags being furthermore connected to a third bag, which contains a sedimentation solution, and to a fourth centrifugation bag, said fourth centrifugation bag being connected to a fifth bag, which contains a preservative solution, and to a sixth bag, which is suitable for preserving blood derivatives, the connections between said bags being constituted by ducts provided with clips, said ducts being connected by multiple-way devices.

11. The apparatus according to claim 10, wherein said third, fifth and sixth bag are connected subsequently or preassembled in sterile conditions.

12. The apparatus according to claim 4, wherein said collection needles is connected to a closed and sterile system of at least two bags, said bags being movable on different levels and being open on two sides, one of said two bags, meant to collect said blood sample, containing the anticoagulant solution and being connected on both sides to the second bag that contains the sedimentation solution, wherein said bag that contains the anticoagulant solution is furthermore connected to a third satellite bag, which contains the preservative solution, and to a fourth bag, which is suitable to preserve the blood fraction of interest.

13. The apparatus according to claim 12, wherein one of the two sides of said bag that contains the anticoagulant solution is connected to said second bag that contains the sedimentation solution by means of a duct that is provided with a cock to allow adequate control of the output flow.

14. The apparatus according to claim 13, wherein said flow is adjusted manually or by means of an automatable system.

15. The apparatus according to claim 12, wherein said second, third and fourth bags are connected subsequently or preassembled in sterile conditions.

16. The invention according to claim 4, wherein said preservative solution is a cryopreservation solution.

17. The invention according to claim 4, wherein the sedimentation solution comprises a sedimentation agent selected from the group that consists of polygeline, hydroxyethyl starches, dextranes, gelatin and mixtures thereof.

18. The invention according to claim 17, wherein the sedimentation solution comprises polygeline.

19. The invention according to claim 18, wherein the sedimentation solution comprising polygeline is a 3.5% solution by weight of polygeline.

20. The invention according to claim 19, wherein the polygeline solution is used in a weight or volume ratio comprised between 2:1 and 5:1 with respect to said blood sample.

21. The invention according to claim 20, wherein the polygeline solution is used in a weight or volume ratio of 3:1 with respect to said blood sample.

22. The invention according to claim 4, wherein the anticoagulant solution comprises at least one substance selected from the group that comprises heparin, CPDA, ACD, sodium citrate and mixtures thereof.

23. The invention according to claim 4, wherein the anticoagulant solution comprises heparin.

24. The invention according to claim 4, wherein said blood sample is selected from the group that consists of cord blood, placental blood, marrow blood, blood obtained from apheresis procedures, and peripheral blood.
